(19) United States
(12) Patent Application Publication
(10) Pub. No.: US 2006/0046679 A1
(43) Pub. Date: Mar. 2, 2006

(54) Flat intermediate if filter for tuners

(76) Inventor: Kam Choon Kwong, Singapore (SG)

Correspondence Address: PHILIPS INTELLECTUAL PROPERTY & STANDARDS, P.O. BOX 3001, BRIARCLIFF MANOR, NY, 10510, US

(21) Appl. No.: 10/533,720

(22) PCT Filed: Oct. 30, 2003
(86) PCT No.: PCT/IB03/04840

§ 371 Date: May 3, 2005

(30) Foreign Application Priority Data
Nov. 8, 2002 (EP) 02102553.1

(51) Int. Cl. H04B 1/18; H04B 1/26

(52) U.S. Cl. 455/293; 455/323

(57) ABSTRACT

The invention describes an intermediate frequency input circuit (1), which is coupled between output nodes of a frequency mixing circuit (2) and input nodes of an intermediate frequency amplifier circuit (3). The intermediate frequency circuit (1) comprises a first inductor (4), a first capacitor (6) and a third capacitor (8), which are in resonance with a lower intermediate frequency and a second inductor (5), a second capacitor (7), a fourth capacitor (8), which are in resonance with an upper intermediate frequency. These resonant frequencies are coupled by a fifth capacitor (10) in order to obtain a flat graph of a frequency characteristic of the intermediate frequency input circuit 1.

The present invention relates to an intermediate frequency input circuit, which is coupled between output nodes of a frequency mixing circuit and input nodes of an intermediate frequency amplifier circuit.

In some television tuners, an intermediate frequency input circuit is connected between output ends of a frequency mixing circuit and input ends of an intermediate frequency amplifier circuit. The intermediate frequency circuit allows a selective intermediate frequency signal of a selector channel to pass while rejecting undesired frequency components that may occur near the intermediate frequency. A rejected frequency component may include an intermediate frequency component of an upper adjacent channel and an intermediate frequency component of a lower adjacent channel. Accordingly, undesired frequency components are not received by the intermediate frequency amplifier circuit.

In the future analog and digital signals are expected to coexist before the full switch to digital signals will be realized. Since the digital transmission is usually reduced in power, the protection from strong adjacent analog channels becomes more critical.

It is, inter alia, an object of the present invention to provide an intermediate frequency input circuit having a flat frequency response for an intermediate frequency of a selector channel and providing sufficient suppression of adjacent channels.

The present invention solves the described problem by providing an intermediate frequency input circuit, which is connected between output nodes of a frequency mixing circuit and input nodes of an intermediate frequency amplifier circuit. The intermediate frequency input circuit includes a pair of input nodes and a pair of output nodes, a first inductor being coupled between the pair of input nodes and
a second inductor being coupled between the pair of input nodes, a first and a second capacitor, which are coupled between a first input node and a first output node,
a third and a fourth capacitor, which are coupled between a second input node and a second output node and a fifth capacitor, which is coupled between the first capacitor and the fourth capacitor and between the second capacitor and the third capacitor.

Compared with a characteristic of a known intermediate frequency input circuit with this arrangement a flat frequency response over a few MHz for the intermediate frequency of the selector channel is obtained. Additionally a satisfactory trap characteristics for the intermediate frequency component of the upper adjacent channel and for the intermediate frequency component of the lower adjacent channel. The intermediate frequency input circuit is cost effective and gives a flat response with good suppression of the sound and adjacent channels without using traps, which usually need to be aligned during production.

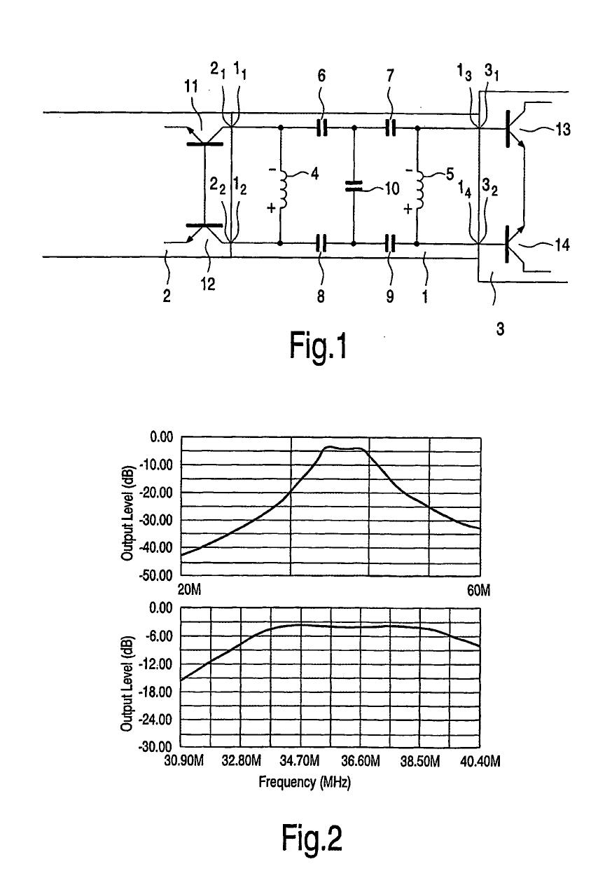

FIG. 1 shows, in a schematic diagram, an embodiment of an intermediate frequency input circuit; and

FIG. 2 is a graph showing an example of a frequency characteristic of the intermediate frequency input circuit shown in FIG. 1.

The present invention is illustrated from the following description of the preferred embodiment and the accompanying drawings.

FIG. 1 shows an embodiment of an intermediate frequency input circuit 1. The intermediate frequency input circuit 1 is coupled between a frequency mixing circuit 2 and an intermediate frequency amplifier circuit 3.

The intermediate frequency input circuit 1 includes a pair of input nodes 1₁ and 1₂, a pair of output nodes 1₃ and 1₄, a first inductor 4, a second inductor 5, a first and a second capacitor 6 and 7, a third and a fourth capacitor 8 and 9, and a fifth capacitor 10.

The frequency mixing circuit 2 includes a pair of input nodes 2₁ and 2₂ a pair of output transistors 11 and 12 in a common-base configuration.

The intermediate frequency amplifier circuit 3 includes a pair of input nodes 3₁ and 3₂ and a pair of input transistors 13 and 14 in a common-emitter configuration.

In the intermediate frequency input circuit 1, the first inductor 4 is coupled between the pair of input nodes 1₁ and 1₂. Between one input node 1₁ and one output node 1₃ the first capacitor 6 and the second capacitor 7 are coupled in series, whereby the first capacitor is coupled to input node 1₁ and to the second capacitor 7. The second capacitor 7 is coupled to the output node 1₃. The second inductor 5 is coupled between the pair of output nodes 1₃ and 1₄. Between one input node 1₂ and one output node 1₄ the third capacitor 8 and the second capacitor 9 are coupled in series, whereby the third capacitor is coupled to input node 1₂ and to the fourth capacitor 9. The fourth capacitor 9 is also coupled to the output node 1₄.

In the frequency mixing circuit 2 a collector of one output transistor 11 is coupled to one output node 2₁, and a collector of the other output transistor 12 is coupled to the other output node 2₂.

In the intermediate frequency amplifier circuit 3 a base of one input transistor 13 is coupled to one input node 3₁, and a base of the other input transistor 14 is coupled to the other input node 3₂.

The pair of input nodes 1₁ and 1₂ of the intermediate frequency input circuit 1 is coupled to the pair of output nodes 2₁ and 2₂ of the frequency mixing circuit 2. The pair of output nodes 1₃ and 1₄ of the intermediate frequency input circuit 1 is coupled to the pair of input nodes 3₁ and 3₂ of the intermediate frequency amplifier circuit 3.

In the preferred intermediate frequency the input circuit 1, the inductance of the first inductor 4 and the capacitance of the first and third capacitors 6 and 8 are selected so that the first inductor 4 and the first and third capacitors 6 and 8 are in resonance with a lower intermediate frequency of the selector channel. The inductance of the second inductor 5 and the capacitance of the second and fourth capacitors 7 and 9 are selected so that the second inductor 5 and the second and fourth capacitors 7 and 9 are in resonance with an upper intermediate frequency of the selector channel. By coupling the component of the lower resonant frequency and the upper resonant frequency with the fifth capacitor 10 a flat frequency response over a few MHz of the intermediate frequency input circuit 1 can be obtained.

The intermediate frequency input circuit 1 operates as follows. An intermediate frequency signal (hereinafter referred to as an “IF signal”) of the selector channel passes through the pair of output nodes 2₁ and 2₂ of the frequency mixing circuit 2. The IF signal includes undesired frequency components. It is received by the intermediate frequency input circuit 1 through the pair of input nodes 1₁ and 1₂. The first inductor 4 and the first and third capacitors 6 and 8 select lower intermediate frequencies of the selector channel. The second inductor 5 and the second and fourth capacitors 7 and 9 select upper intermediate frequency of the selector channel. The adjusted IF signal is passed through the pair of output nodes 1₃ and 1₄ and is received by the pair of input nodes 3₁ and 3₂ of the intermediate frequency amplifier circuit 3. The IF signal is then preferably amplified by the pair of input transistors 13 and 14.

FIG. 2 shows an example of a frequency characteristic of the intermediate frequency input circuit shown in FIG. 1. The inductance of the first inductor 4 and the capacitance of the first and third capacitors 6 and 8 are selected so that the lower resonant frequency is 34.47 MHz and the inductance of the second inductor 5 and the capacitance of the second and fourth capacitors 7 and 9 are selected so that the upper resonant frequency is 38.9 MHz. The bandwidth of the intermediate frequency input circuit is adjusted by the fifth capacitor 10.

1. An intermediate frequency circuit (1), which is connected between a frequency mixing circuit (2) and an intermediate frequency amplifier circuit (3), the intermediate frequency circuit (1) comprising:
a pair of input nodes (1₁, 1₂);
a pair of output nodes (1₃, 1₄);
a first inductor (4) being coupled between the pair of input nodes (1₁, 1₂);
a second inductor (5) being coupled between the pair of output nodes (1₃, 1₄);
a first and a second capacitor (6, 7), which are coupled between a first input node (1₁) and a first output node (1₃);
a third and a fourth capacitor (8, 9), which are coupled between a second input node (1₂) and a second output node (1₄); and
a fifth capacitor (10), which is coupled between the first capacitor (6) and the fourth capacitor (8) and between the second capacitor (7) and the third capacitor (8).

2. The intermediate frequency circuit of claim 1, wherein said first capacitor (6) is coupled in series to said second capacitor (7); and
said third capacitor (8) is coupled in series to said fourth capacitor (9).
